(19) United States
(12) Patent Application Publication
(10) Pub. No.: US 2025/0214383 A1
(43) Pub. Date: Jul. 3, 2025

(54) METHOD AND DEVICE FOR COMMUNICATING BETWEEN AN ELECTRONIC MODULE AND A REMOTE CONTROL DEVICE

(71) Applicant: Continental Automotive Technologies GmbH, Hannover, DE (US)

(72) Inventors: Jean-Philippe BOISSET, MONTAUBAN (FR); Arnaud PROCHASKA, BACH (FR)

(73) Assignee: Continental Automotive Technologies GmbH, Hannover, DE (US)

(21) Appl. No.: 18/905,323

(22) Filed: Oct. 3, 2024

(30) Foreign Application Priority Data
Dec. 27, 2023 (FR) FR2315337

(51) Int. Cl. B60C 23/04; H04B 17/318

(52) U.S. Cl. CPC B60C 23/0444; B60C 23/0438; H04B 17/318

(57) ABSTRACT

A device, a system and a method for two-way communication between an electronic module from among a plurality of electronic modules and a remote control device. The method includes: transmitting, by the remote control device, which includes at least two switchable directional antennas having different transmission directions, a command through its at least two switchable directional antennas intended for the plurality of electronic modules; and identifying an electronic module from among the plurality of electronic modules that is identified as being opposite the remote control device, with the communication only being established between the remote control device and the electronic module from among the plurality of electronic modules that is identified as being opposite the remote control device.

### CROSS REFERENCE TO RELATED APPLICATIONS

This application claims priority to French Patent Application No. 2315337, filed Dec. 27, 2023, the contents of such application being incorporated by reference herein.

### FIELD OF THE INVENTION

The present invention relates to a method for communicating between an electronic module and a remote control device, as well as to a communication device and system for implementing this device.

It notably relates to tire pressure monitoring systems.

### BACKGROUND OF THE INVENTION

With a view to enhancing safety, an increasing number of motor vehicles are currently fitted with tire pressure monitoring systems. These systems, also called TPMS (for “Tire Pressure Monitoring Systems”), allow useful parameters such as the inflation pressure or the temperature of the tires to be constantly available by means of sensors installed on the wheels of the vehicle. If necessary, the vehicle driver thus can be warned of any situation relating to the state of the tires that may affect the vehicle driving conditions, or that may even create a risk to them and any of their passengers. Additionally, the information collected by these sensors also can be used by other on-board electronic systems in the vehicle in order to fulfil their specific function.

A TPMS is conventionally made up of two parts. On the one hand, it comprises electronic modules, which are respectively fitted in each wheel of the vehicle. These modules each at least integrate an electronic circuit, a low-frequency radio receiver (for receiving signals at a frequency of around 125 kHz) and a high-frequency radio transmitter (for transmitting signals at a frequency of around 315 MHz or around 434 MHz), as well as a battery for supplying them with electricity. These modules, also called “wheel units” (or WU) hereafter, are intended for measuring the various aforementioned operating parameters of the wheel, using sensors integrated into their electronic circuits. On the other hand, a TPMS comprises a central unit at least integrating a high-frequency radio receiver receiving the signals transmitted by the wheel units (also called radio frequency or RF signals). The central unit is capable of distinguishing, analyzing and using the information that it receives from each wheel unit in this way.

Depending on the models used, the wheel units can be arranged inside a tire by being attached to the valve of the tire or to the inner face of its tread. In all cases, they regularly measure at least the pressure and the temperature of the tire at this point. They periodically transmit corresponding information (typically approximately every 16 seconds) to the central unit, accompanied by a unique wheel identifier enabling the central unit to distinguish the specific wheel that is the source of the received signals. The periodic nature and the frequency of these transmissions are directly related to the energy consumption constraints that must be met by the batteries that are integrated into the wheel units. Indeed, these batteries, which are subject to limitations in terms of cost and overall dimensions, must also enable the wheel unit to have a service life (i.e., operating periods without requiring replacement) of approximately 10 years, notably in order to meet the expectations of customers and users.

As described above, the communications between the wheel units and the central unit of a TPMS occur by means of radio frequency signals at specified frequencies of the order of several hundred megahertz (MHz).

Additionally, the presence of a radio wave receiver, for low frequencies of the order of several hundred kilohertz (also called an LF (Low-Frequency) signal), in each wheel unit is intended for diagnostics or configuration or training operations on the relevant wheel unit. Indeed, an external tool can be used in a maintenance or repair workshop for configuring the functionalities or for diagnosing any faults in a wheel unit, by sending it commands for this purpose using an LF signal.

The frequency bands of the signals described above provide means for wirelessly exchanging data that are reliable, secure and relatively energy-saving. However, technological developments have highlighted the value of the potential use of signals in other, higher, frequency bands for communicating with the wheel units, with the aim of offering the user other “experiences”. In particular, the widespread use of portable communication devices for users, called “smart devices”, such as smart phones, tablets or smart watches, for example, using ultra-high frequency (UHF) radio waves, i.e. at frequencies exceeding a gigahertz (Wi-Fi, Bluetooth®, 4G, etc.), paves the way for highly promising advanced functionalities. This allows, by virtue of the TPMS, a greater capacity to be provided for interacting with the user, notably by using the two-way communications that can be established between said smart devices and some or all of the wheel units of a TPMS.

Thus, for example, it would be easy for the user of a vehicle to know the pressure of each tire in real time, i.e. even when they are not in their vehicle, and to be warned of the critical deflation of a tire long before they access their vehicle in order to use it. Thus, the user would avoid the inconvenience of finding a flat tire when they wish to make a journey in their vehicle. Thus, they could make the necessary repair in advance, and/or make other travel arrangements so as to be able to travel and avoid missing an appointment, for example.

Moreover, the user could also access their car without a key (referred to as “hands free” access), directly by using their smart phone to communicate with the vehicle for this purpose, using the communication means of the TPMS. In particular, such a functionality would be based on the authentication and location of the smart phone of a user, via its exchanges with the wheel units of the TPMS.

Finally, using UHF radio waves at frequencies allowing communication between a smart device and the units of a TPMS would avoid, for the existing functionalities, having to use a specific interface of the vehicle (whether this is a visual or audio interface) for notifying the user of useful information on their smart phone. Furthermore, it would also allow new functionalities to be fulfilled, based on the direct interactivity between this smart device of the user and the vehicle.

In summary, the use of UHF radio waves at frequencies of the order of a gigahertz for wirelessly exchanging data with the wheel units of a TPMS would thus lead to an enhanced “user experience”. Finally, the type of signal used to establish such a wireless communication is selected so as to offer both high enough security guarantees (in view of legal requirements) and a range that is suitable for the considered data exchanges.

One approach that can be contemplated involves using transceivers for UHF signals at a frequency of more than a gigahertz that are directly installed in the wheel units of a TPMS. This approach has, for example, already been contemplated with the use of a low-consumption Bluetooth® signal at 2.4 GHz, also referred to as a BLE (“Bluetooth Low Energy”) signal. Above all, this allows relevant information to be transmitted directly to the user on their smart device concerning the state of the tires that is obtained from measurements from the wheel unit sensors. It also allows, by using the ability of the wheel units to detect such signals in their environment, precise location of a user, and, if necessary, allows their movement in this environment to be known (in other words, in the immediate environment, around the vehicle itself). Such location has proved useful for providing a reactive and efficient function for “hands free” access to the vehicle, for example by allowing detection of the side from which the user is approaching the vehicle, and for accordingly carrying out actions. Finally, integrating UHF transceivers for such signals into the wheel units and/or into the central unit of a TPMS forms part of an overall aim of development toward future systems that are functionally more enhanced. Indeed, UHF radio signals can be used both for inter-unit communications within the TPMS and for carrying out the configuration or diagnosis of the systems, or for other, future functions that are, or will be, specific to the function of the TPMS.

However, as it stands, this approach entails a significant limit to its effective implementation, and notably concerning the integration of a UHF receiver in the wheel unit, replacing the low-frequency (LF) radio wave receiver. Indeed, within the context of using an external tool during production or in a maintenance or repair workshop for configuring the functionalities or for diagnosing any faults in a wheel unit, the presence of the LF receiver in the wheel unit allows the tool itself to send commands for this purpose using an LF signal. Due to the LF communication that is established between the tool and the wheel unit, a command transmitted by the tool is only received by the wheel unit closest to the tool. Thus, by positioning the tool opposite a designated wheel unit, and optionally involving an adjustment of the transmission strength of the tool, it is possible to diagnose or configure a wheel unit, without requiring any prior identification of the wheel unit to establish this LF communication.

However, integrating a UHF receiver in the wheel unit in order to replace an LF receiver means that the tool can no longer be guaranteed to be solely communicating with the nearest wheel unit, as the UHF receivers of remote wheel units can also receive a command transmitted by the tool and respond to said command. In this case, varying the transmission strength is not sufficient for discriminating between wheel units.

FIG. 1 shows a graph of reception strengths of signals received by a tool, with the time in ms on the abscissa and the received strength in dBM on the ordinate. The graph therefore illustrates the strengths required for the tool to receive four response signals transmitted by four wheel units following an RF command transmitted by the tool with a fixed strength, with the responses ranging between −50 dBM and −110 dBM. The wheel units are arranged at different distances from the tool, and the signal strength received by the tool, also known as RSSI (Received Signal Strength Indication), notably depends on the distance between the transmitter and the receiver. This graph notably shows the overlap between the various responses received by the tool, such that there is a risk of possible confusion between the various wheel units due to the signal sensitivity levels of each wheel unit. This overlap is notably due to the particular configuration of the two-way UHF communication, notably Bluetooth® Low Energy (called BLE). Indeed, the communication uses a plurality of UHF channels one after the other, for example three UHF channels, operating at different frequencies. As the RSSI levels are not the same depending on the channels, this contributes to the “fog” illustrated in FIG. 1.

Intervening in order to vary only the strength of the RF command transmitted by the tool would not be enough for discriminating between the received UHF responses, and this is especially true when taking into account the environment in which these RF-UHF communications occur, which is not favorable (notably due to the existence of reflections, for example).

Therefore, the wheel unit fitted with a UHF transmitter and which is closest to an RF command tool, within the context of RF-UHF communications, needs to be easily and unambiguously identifiable.

### SUMMARY OF THE INVENTION

Therefore, an aim of the present invention is to allow a given wheel unit to be identified, notably by a diagnostics or configuration tool, with a view to communicating with said tool.

According to an aspect of the invention, this aim is achieved by virtue of a method for communicating according to a communication protocol allowing short-range two-way data exchanges using ultra-high frequency radio waves between an electronic module from among a plurality of electronic modules and a remote control device, characterized in that it comprises:
a step of transmitting, by the remote control device, which comprises at least two switchable directional antennas having different transmission directions, a command through its at least two switchable directional antennas that is intended for the plurality of electronic modules; a step of identifying an electronic module from among the plurality of electronic modules that is identified as being opposite the remote control device, with the communication only being established between the remote control device and the electronic module from among the plurality of electronic modules that is identified as being opposite the remote control device.

An aspect of the present invention therefore allows, by reducing the dispersion of the received strength measurements, and by adding an additional source of information (such as the direction of the transmitted signal), the remote wheel units to be rejected with a significant margin, and to thus identify a given wheel unit without any ambiguity (namely the one opposite the tool).

According to an advantageous embodiment, the communication method comprises an additional mapping step, wherein:
the remote control device transmits a basic signaling message;
upon detection by an electronic module of a basic signaling message transmitted by the remote control device, the electronic module transmits a standard response message,
with the remote control device thus being aware of the electronic modules located in the vicinity.

According to another advantageous embodiment, the standard response message transmitted by the electronic module upon detection of a basic signaling message transmitted by the remote control device comprises an identifier of the electronic module.

According to an advantageous embodiment, the step of identifying the electronic module opposite the remote control device comprises the following steps:
the remote control device, which comprises at least two switchable directional antennas having different transmission directions, transmits a transmission command through its at least two switchable directional antennas that is intended for the plurality of electronic modules;
the plurality of electronic modules respond to this same command transmitted by the remote control device by transmitting a response signal;
an electronic module is identified as being opposite the remote control device if:
a strength level of the response signals associated with this electronic module and received by each of the at least two switchable directional antennas of the remote control device is greater than a first predefined threshold; and
a difference in strength levels of the response signals associated with this electronic module and received by the at least two switchable directional antennas of the remote control device is less than a second predefined threshold.

According to another embodiment, the step of identifying the electronic module opposite the remote control device comprises the following steps:
the remote control device, which comprises at least two switchable directional antennas having different transmission directions, transmits a transmission command through its at least two switchable directional antennas that is intended for the plurality of electronic modules in the form of a plurality of frames, with each of the transmitted frames comprising an identifier of the switchable directional antenna that is used;
an electronic module is identified as being opposite the remote control device if:
a reception strength level received by the electronic module of the frames transmitted by each of the at least two switchable directional antennas of the remote control device is greater than a first predefined threshold; and
a difference in the reception strength levels received by the electronic module of the frames transmitted by each of the at least two switchable directional antennas of the remote control device is less than a second predefined threshold.

According to an advantageous embodiment, the method is also noteworthy in that the frames transmitted by the remote control device also include a transmission strength level of the transmission command, and in that it is also possible to determine a distance separating the remote control device and the electronic module based on the transmission strength level of each of the frames and on a reception strength level determined by each electronic module, with an electronic module being identified as being opposite the remote control device if a difference in determined distances based on the frames transmitted by each of the at least two switchable directional antennas of the remote control device is less than a predefined threshold.

According to an advantageous embodiment, the strength level is established over at least four signals successively received by the remote control device or by the electronic modules.

According to one embodiment, the identifier of the electronic module is a specific address stored in a physical memory for controlling access to the medium of the electronic module.

According to an advantageous embodiment:
when the remote control device intends to transmit transmission commands only toward the electronic module opposite the remote control device,
and when the module opposite the remote control device is identified by its identifier for an electronic module,
then the subsequent transmission commands from the remote control device can be directional and include the identifier of the electronic module opposite the remote control device concerned with said transmission commands, with said device then processing these transmission commands.

An aspect of the invention also relates to a remote control device for implementing a communication method according to any one of the aforementioned features, noteworthy in that it comprises:
at least two phase-shifted switchable directional antennas; and
radio frequency switches.

Preferably and advantageously, the device comprises two phase-shifted switchable directional antennas assuming an angle that is greater than 45°.

Advantageously, the device comprises two switchable directional antennas phase-shifted by 90°.

According to another advantageous embodiment, the device comprises two rows of at least two switchable directional antennas, with the two rows of at least two switchable directional antennas being phase-shifted by an angle that is greater than 45°, and, advantageously, the two rows of at least two switchable directional antennas are phase-shifted by 90°.

An aspect of the invention also relates to a system for implementing the communication method having any one of the aforementioned features, characterized in that it comprises:
at least one remote control device having at least one of the aforementioned features;
at least two electronic modules configured to communicate in accordance with a communication protocol allowing short-range two-way data exchanges using ultra-high frequency radio waves.

According to one embodiment, the electronic modules are wheel units of a tire pressure monitoring system for a vehicle.

### BRIEF DESCRIPTION OF THE DRAWINGS

Further features and advantages of aspects of the invention will become more clearly apparent upon reading the following description. This description is purely illustrative and should be read with reference to the appended drawings, in which:

FIG. 1 shows a graph of reception strengths of signals received by a tool, with the time in ms on the abscissa and the received strength in dBM on the ordinate;

FIG. 2 is a schematic representation of a motor vehicle provided with a tire monitoring system capable of communicating with a remote control device;

FIG. 3 schematically illustrates a remote control device according to an aspect of the invention;

FIG. 4 shows an example of the use of the control device in a communication system according to an aspect of the invention;

FIG. 5 shows strength readings of signals received by the device according to an aspect of the invention.

### DETAILED DESCRIPTION OF EXEMPLARY EMBODIMENTS

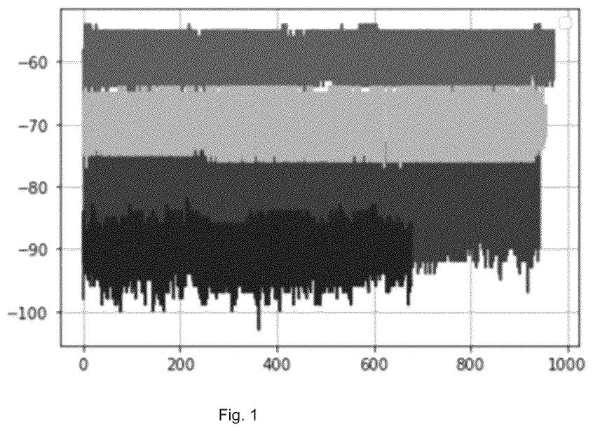

FIG. 1 has already been described in the introductory part of the present application.

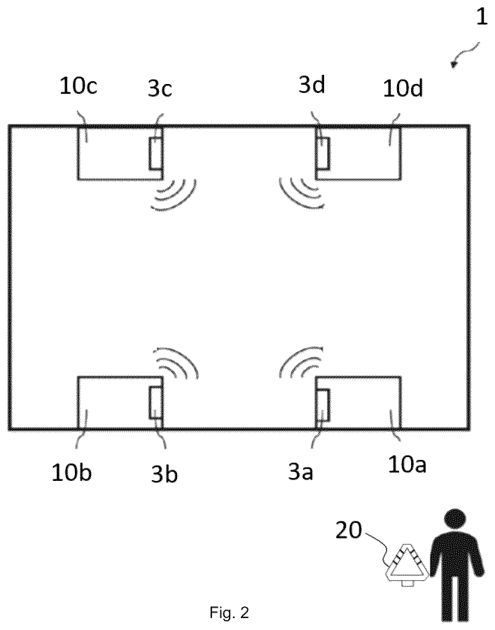

FIG. 2 schematically illustrates a communication system according to an aspect of the invention comprising:
at least one remote control device 20;
four electronic modules 3a, 3b, 3c, 3d configured to communicate in accordance with a communication protocol allowing short-range two-way data exchanges using ultra-high frequency radio waves.

In a by no means limiting manner, the communication system of FIG. 2 is a system for monitoring the tires of a motor vehicle 1, with the system comprising electronic modules, also called wheel units, 3a, 3b, 3c, 3d, each associated with a wheel 10a, 10b, 10c, 10d of the vehicle.

For the sake of the simplicity of the description, the description provided for one electronic module 3 is valid for all the electronic modules of a motor vehicle previously denoted 3a to 3d in FIG. 2.

The electronic modules 3 can communicate with the remote control device 20. This remote control device 20 is, for example, a diagnostic or configuration tool used during production or in a maintenance or repair workshop to configure the functionalities of an electronic module, to diagnose any faults in an electronic module or to collect data therefrom. This communication between the electronic modules 3 and the remote control device 20 occurs according to a communication protocol for short-range two-way data exchanges using ultra-high frequency radio waves, advantageously according to a communication protocol of the Bluetooth® type.

To this end, the electronic module 3 comprises a UHF module provided with a UHF transmitter and a UHF receiver, a microprocessor and storage means. The two-way exchanges can relate to multiple UHF channels differing in terms of UHF frequency. The most frequently used UHF communication can provide three channels, but there could be more. It is possible to have up to 25 UHF channels for the same UHF module fitted to an electronic module 3. For example, the signaling messages use three frequency channels. The rest of the channels are dedicated to the connected mode.

The remote control device 20 comprises at least two switchable directional antennas that are phase-shifted relative to each other by an angle α that is advantageously greater than 45° and is 90°, for example. More specifically, the directions of the radiation lobes of the antennas are at 90° to each other. The remote control device 20 comprises radio frequency switches that are known per se.

Advantageously, the remote control device 20 comprises two rows 21 of at least two phase-shifted switchable directional antennas 22. Advantageously, the two rows 21 of at least two switchable directional antennas 22 are phase-shifted by an angle α that is greater than 45°.

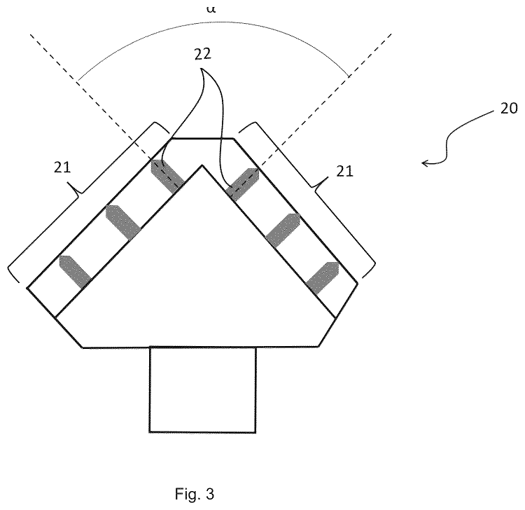

With reference to FIG. 3, the remote control device 20 comprises two rows 21 of three switchable directional antennas 22. The two rows 21 of three switchable directional antennas 22 are phase-shifted by an angle α of 90°, with one row 21 of antennas 22 being oriented to the left of the remote control device 20 and one row 21 of antennas 22 being oriented to the right of the remote control device 20.

The switching method according to an aspect of the invention will now be described.

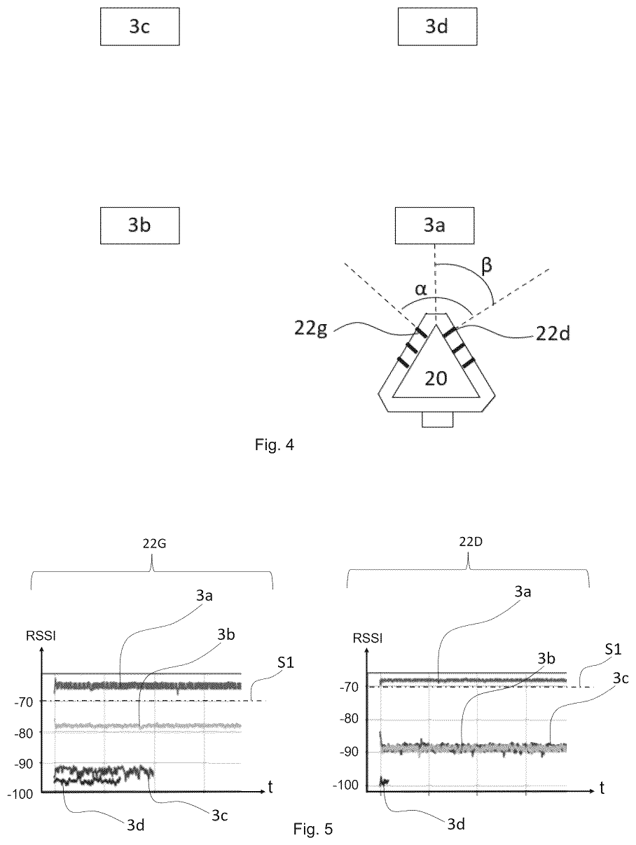

FIG. 4 illustrates a communication system according to an aspect of the invention comprising a remote control device 20 comprising two rows of three antennas 22, and four electronic modules 3a, 3b, 3c, 3d positioned in the immediate environment of the remote control device 20.

The communication method according to an aspect of the invention includes an optional preliminary mapping step allowing the remote control device 20 to become aware of the electronic modules 3a, 3b, 3c, 3d located in its immediate environment.

In order to carry out this mapping step, the remote control device 20 transmits a basic signaling message. The basic signaling messages sent by the remote control device 20 have the advantage of being simple, of not containing data, and may not be addressed, except in special cases, to a specific electronic module; they are only used to indicate the presence of the remote control device 20 to the electronic modules present in its environment.

When an electronic module 3a, 3b, 3c, 3d detects the basic signaling message transmitted by the remote control device 20, the electronic module 3a, 3b, 3c, 3d transmits a standard response message. This standard response message does not contain any specific data, but when it is sent by the electronic module 3a, 3b, 3c, 3d and received by the remote control device 20 then it is interpreted by said remote control device as being information relating to the presence of the remote control device 20 in the immediate environment. Advantageously, the standard response message transmitted by the electronic module 3a, 3b, 3c, 3d upon detection of a basic signaling message transmitted by the remote control device 20 comprises an identifier of the electronic module 3a, 3b, 3c, 3d. This identifier of the electronic module 3a, 3b, 3c, 3d is, for example, a specific address stored in a physical memory for controlling access to the medium of the electronic module (also called “Media Access Control” or abbreviated to “MAC”).

When an operator wishes to configure an electronic module 3a of interest or to retrieve data from said electronic module 3a with a view, for example, to carrying out diagnostics, they position themselves close to said electronic module 3a and orient the remote control device 20 opposite said electronic module 3a.

During a transmission step, the remote control device 20 transmits a command through its antennas 22 that is intended for the plurality of electronic modules 3a, 3b, 3c, 3d present in the environment of the remote control device 20.

During an identification step, the electronic module 3a of interest identifies itself or is identified as being opposite the remote control device 20, which allows communication to be established between the remote control device 20 and the electronic module 3a of interest only, with the other electronic modules 3b, 3c, 3d present in the environment of the remote control device 20 then being ignored.

According to one embodiment of the method according to the invention, the step of identifying the electronic module 3a of interest opposite the remote control device 20 comprises the following sub-steps:
the remote control device 20 transmits a transmission command intended for the plurality of electronic modules 3a, 3b, 3c, 3d located in its environment through its switchable directional antennas 22;
the electronic modules 3a, 3b, 3c, 3d respond to this same command transmitted by the remote control device 20 by transmitting a response signal;
an electronic module 3a is identified as being opposite the remote control device if:
a strength level of the response signals associated with this electronic module 3a and received by each of the switchable directional antennas 22 of the remote control device 20 is greater than a first predefined threshold S1; and
a difference in strength levels of the response signals associated with this electronic module 3a and received by the switchable directional antennas 22 of the remote control device 20 is less than a second predefined threshold S2.

FIG. 5 illustrates two signal strength readings (RSSI) received by the remote control device 20 as a function of time (t). The reading 22G illustrated on the left-hand side of FIG. 5 illustrates the signal strength received by an antenna 22g disposed on the left-hand side of the remote control device 20 and the reading 22D illustrated on the right-hand side of FIG. 5 illustrates the signal strength received by an antenna 22d disposed on the right-hand side of the remote control device 20. Alternatively, the readings can illustrate averages of the strengths received on all the antennas of a left-hand 21 or right-hand 22 row of antennas of the remote control device 20.

When the remote control device 20 is pointed toward the electronic module 3a of interest, due to the 90° phase-shift between the rows 21 of antennas 22, an angle β of the order of 45° is formed between each antenna 22 of each row 21 of antennas and the electronic module 3a opposite the control device 20. This topology allows both the front zone of the control device 20 (visible by each antenna 22) and also, depending on the considered antenna 22, the zone to the left and to the right of the control device 20 to be scanned. Thus, if the electronic module 3a is opposite the control device 20, a field measurement seen by the antennas 22 of the two rows 21 in this case is substantially equivalent, even if the control device 20 is not directly pointed at the electronic module 3a. The other electronic modules 3b, 3c, 3d present in the environment also can be detected by the control device 20 with a high field level, but only on one of the rows of antennas, which allows unequivocal discrimination of the electronic module 3a of interest.

Notably, in FIG. 5, the electronic module 3a is the only module for which:
the strength level of the response signal received by each or by all the switchable directional antennas 22g and 22d of the remote control device 20 is greater than a first predefined threshold S1 of −70 dB, for example (in this case, −65 dB on the left-hand reading 22G and −68 dB on the right-hand reading 22D); and
a difference in strength levels of the response signals received by the switchable directional antennas 22g and 22d of the remote control device 20 is less than a second predefined threshold S2, for example 5 dB by absolute value (in this case, a 3 dB difference by absolute value between the left-hand reading 22G and the right-hand reading 22D).

Advantageously, when the remote control device 20 transmits the transmission command, it transmits a plurality of frames through its switchable directional antennas 22, with each of the transmitted frames comprising an identifier of the switchable directional antenna 22 used for this transmission. In this case, an electronic module 3a is identified as being opposite the remote control device 20 if:
a reception strength level received by the electronic module 3a of the frames transmitted by each of the switchable directional antennas 22 is greater than a first predefined threshold S′1; and
a difference in the reception strength levels received by the electronic module 3a of the frames transmitted by each of the switchable directional antennas 22 is less than a second predefined threshold S′2.

According to one embodiment, the frames transmitted by the remote control device 20 also include information concerning the transmission strength level of the transmission command. It is then possible to determine a distance separating the remote control device 20 and the electronic module 3a, 3b, 3c, 3d based on the transmission strength level of each of the frames and on a reception strength level determined by each electronic module 3a, 3b, 3c, 3d. Thus, an electronic module 3a is identified as being opposite the remote control device 20 if a difference in distances that are determined based on the frames transmitted by each of the switchable directional antennas 22 of the remote control device 20 is less than a predefined threshold S3.

Advantageously, irrespective of the embodiment, the strength level is established, for example, over at least four signals successively received by the remote control device 20 or by the electronic modules 3a, 3b, 3c, 3d. Indeed, in a communication protocol allowing short-range two-way exchanges of data using ultra-high frequency radio waves, for example of the Bluetooth® type, the messages are transmitted over several frequency channels, generally over three frequency channels. This results in noise being generated during the various exchanges between the remote control device 20 and the electronic modules 3a, 3b, 3c, 3d. In this way, establishing the strength level on several successively received signals allows the impact of this noise to be reduced.

An aspect of the present invention thus allows a remote control device 20 to simply, quickly and efficiently start communicating with an electronic module of interest. Notably, when the remote control device 20 intends to transmit transmission commands only toward the electronic module 3a of interest located opposite the remote control device 20, and when the electronic module 3a opposite the remote control device 20 is identified by its electronic module identifier, then the subsequent transmission commands from the remote control device 20 can be directional and include the identifier of the electronic module 3a concerned with said transmission commands, with the electronic module 3a opposite the remote control device 20 then processing these transmission commands.

Therefore, an aspect of the present invention also relates to an electronic module 3 comprising an application-specific integrated circuit with a microprocessor for controlling the module, provided with a microprocessor and storage means, with the integrated circuit of the electronic module implementing a communication method as described above.

The electronic module 3 also comprises an ultra-high frequency communication module for communicating according to a communication protocol, for example of the Bluetooth® type, with an antenna for communicating, by reception and by transmission, with communication devices according to a protocol, for example of the Bluetooth® type, and electronic components that may or may not be at least partially integrated into the integrated circuit. For example, the communication module can comprise a microprocessor, a crystal-controlled clock and storage means.

An aspect of the present invention therefore allows, by reducing the dispersion of the received strength measurements, and by adding an additional source of information (such as the direction of the transmitted signal), the outlying electronic modules to be rejected with a significant margin, and to thus identify an electronic module of interest without any ambiguity (namely the one opposite the remote control device).

An aspect of the present invention is of particular interest in any field requiring the location of electronic modules 3 where only the transmitter can include directional antennas.

1. A method for communicating according to a communication protocol allowing short-range two-way data exchanges using ultra-high frequency radio waves between an electronic module from among a plurality of electronic modules and a remote control device, the method comprising:
a step of transmitting, by the remote control device, which comprises at least two switchable directional antennas having different transmission directions, a command through its at least two switchable directional antennas that is intended for the plurality of electronic modules; and
a step of identifying an electronic module from among the plurality of electronic modules that is identified as being opposite the remote control device,
with the communication only being established between the remote control device and the electronic module from among the plurality of electronic modules that is identified as being opposite the remote control device.

2. The communication method as claimed in claim 1, further comprising a preliminary mapping step, wherein:
the remote control device transmits a basic signaling message;
upon detection by an electronic module of a basic signaling message transmitted by the remote control device, the electronic module transmits a standard response message,
with the remote control device thus being aware of the electronic modules located in the vicinity.

3. The communication method as claimed in claim 2, wherein the standard response message transmitted by the electronic module upon detection of a basic signaling message transmitted by the remote control device comprises an identifier of the electronic module.

4. The communication method as claimed in claim 1, wherein the step of identifying the electronic module opposite the remote control device comprises the following steps:
the remote control device, which comprises at least two switchable directional antennas having different transmission directions, transmits a transmission command through its at least two switchable directional antennas that is intended for the plurality of electronic modules;
the plurality of electronic modules respond to this same command transmitted by the remote control device by transmitting a response signal;
an electronic module is identified as being opposite the remote control device if:
a strength level of the response signals associated with this electronic module and received by each of the at least two switchable directional antennas (22) of the remote control device is greater than a first predefined threshold; and
a difference in strength levels of the response signals associated with this electronic module and received by the at least two switchable directional antennas of the remote control device is less than a second predefined threshold.

5. The communication method as claimed in claim 1, wherein the step of identifying the electronic module opposite the remote control device comprises the following steps:
the remote control device, which comprises at least two switchable directional antennas having different transmission directions, transmits a transmission command through its at least two switchable directional antennas that is intended for the plurality of electronic modules in the form of a plurality of frames, with each of the transmitted frames comprising an identifier of the switchable directional antenna that is used;
an electronic module is identified as being opposite the remote control device if:
a reception strength level received by the electronic module of the frames transmitted by each of the at least two switchable directional antennas of the remote control device is greater than a first predefined threshold; and
a difference in the reception strength levels received by the electronic module of the frames transmitted by each of the at least two switchable directional antennas of the remote control device is less than a second predefined threshold.

6. The communication method as claimed in claim 5, wherein the frames transmitted by the remote control device also include a transmission strength level of the transmission command, and in that it is also possible to determine a distance separating the remote control device and the electronic module based on the transmission strength level of each of the frames and on a reception strength level determined by each electronic module, with an electronic module being identified as being opposite the remote control device if a difference in determined distances based on the frames transmitted by each of the at least two switchable directional antennas of the remote control device is less than a predefined threshold.

7. The communication method as claimed in claim 1, wherein the strength level is established on at least four signals successively received by the remote control device or the electronic modules.

8. The communication method as claimed in claim 3, wherein the identifier of the electronic module is a specific address stored in a physical memory for controlling access to the medium of the electronic module.

9. The communication method as claimed in claim 6, wherein:
when the remote control device intends to transmit transmission commands only toward the electronic module opposite the remote control device,
and when the electronic module opposite the remote control device is identified by its identifier for an electronic module,
then the subsequent transmission commands from the remote control device can be directional and include the identifier of the electronic module opposite the remote control device concerned with said transmission commands, with said device then processing these transmission commands.

10. A remote control device for implementing a communication method as claimed in claim 1, comprising:
at least two phase-shifted switchable directional antennas; and
radio frequency switches.

11. The remote control device as claimed in claim 10, further comprising two switchable directional antennas phase-shifted by an angle that is greater than 45°.

12. The remote control device as claimed in claim 10, further comprising two switchable directional antennas phase-shifted by 90°.

13. The remote control device as claimed in claim 10, further comprising two rows of at least two switchable directional antennas, with the two rows of at least two switchable directional antennas being phase-shifted.

14. The remote control device as claimed in claim 13, wherein the two rows of at least two switchable directional antennas are phase-shifted by an angle that is greater than 45°.

15. A system for implementing the communication method as claimed in claim 1, comprising:
at least one remote control device comprising at least two phase-shifted switchable directional antennas and radio frequency switches; and
at least two electronic modules configured to communicate in accordance with a communication protocol allowing short-range two-way data exchanges using ultra-high frequency radio waves.

16. The system as claimed in claim 15, wherein the electronic modules are wheel units of a tire pressure monitoring system for a vehicle.
